(19) United States
(12) Patent Application Publication
(10) Pub. No.: US 2013/0272420 A1
(43) Pub. Date: Oct. 17, 2013

(54) VIDEO ENCODING AND DECODING WITH IMPROVED ERROR RESILIENCE

(71) Applicants: Guillaume Laroche, Melesse (FR); Christophe Gisquet, Rennes (FR)

(72) Inventors: Guillaume Laroche, Melesse (FR); Christophe Gisquet, Rennes (FR)

(73) Assignee: CANON KABUSHIKI KAISHA, Tokyo (JP)

(21) Appl. No.: 13/976,398

(22) PCT Filed: Dec. 28, 2011
(86) PCT No.: PCT/EP11/74174

§ 371 Date: Jun. 26, 2013

(30) Foreign Application Priority Data
Dec. 29, 2010 (GB) 1022052.3

(51) Int. Cl. H04N 7/36

(52) U.S. Cl. CPC H04N 19/00587
USPC 375/240.16

(57) ABSTRACT

A sequence of digital images is encoded into a plurality of encoding units. An image portion is encoded by motion compensation with respect to a reference image portion indicated by an item of motion information. A motion information predictor is determined among a set of motion information predictors and the item of motion information is encoded with respect to the motion information predictor. It is determined to encode the motion information predictors of an encoding unit using either a first encoding mode, which provides encoded data efficiently compressed but not parseable by a decoder in case of losses in the bitstream, or a second encoding mode which provides encoded data less efficiently compressed but systematically parseable by a decoder even in case of losses in the bitstream.

### CROSS-REFERENCE TO RELATED APPLICATIONS

This application claims the benefit under 35 U.S.C. §119(a)-(d) of United Kingdom Patent Application No. 1022052.3, filed on Dec. 29, 2010 and entitled “Video Encoding and Decoding with Improved Error Resilience”. The above cited patent application is incorporated herein by reference in its entirety.

### BACKGROUND OF THE INVENTION

1. Field of the Invention

The invention relates to a method and device for encoding a sequence of digital images and a method and device for decoding a corresponding bitstream.

The invention belongs to the field of digital signal processing, and in particular to the field of video compression using motion compensation to reduce spatial and temporal redundancies in video streams.

2. Description of the Related Art

Many video compression formats, for example H.263, H.264, MPEG-1, MPEG-2, MPEG-4, SVC, use block-based discrete cosine transform (DCT) and motion compensation to remove spatial and temporal redundancies. They can be referred to as predictive video formats. Each frame or image of the video signal is divided into slices which are encoded and can be decoded independently. A slice is typically a rectangular portion of the frame, or more generally, a portion of an image. Further, each slice is divided into macroblocks (MBs), and each macroblock is further divided into blocks, typically blocks of 8×8 pixels. The encoded frames are of two types: temporal predicted frames (either predicted from one reference frame called P-frames or predicted from two reference frames called B-frames) and non temporal predicted frames (called Intra frames or I-frames).

Temporal prediction consists in finding in a reference frame, either a previous or a future frame of the video sequence, an image portion or reference area which is the closest to the block to encode. This step is known as motion estimation. Next, the difference between the block to encode and the reference portion is encoded (motion compensation), along with an item of motion information relative to the motion vector which indicates the reference area to use for motion compensation.

In order to further reduce the cost of encoding motion information, it has been proposed to encode a motion vector by difference from a motion vector predictor, typically computed from the motion vectors of the blocks surrounding the block to encode.

In H.264, motion vectors are encoded with respect to a median predictor computed from the motion vectors situated in a causal neighbourhood of the block to encode, for example from the blocks situated above and to the left of the block to encode. Only the difference, also called residual motion vector, between the median predictor and the current block motion vector is encoded.

The encoding using residual motion vectors saves some bitrate, but necessitates that the decoder performs the same computation of the motion vector predictor in order to decode the value of the motion vector of a block to decode.

Recently, further improvements have been proposed, such as using a plurality of possible motion vector predictors. This method, called motion vector competition (MVCOMP), consists in determining between several motion vector predictors or candidates which motion vector predictor minimizes the encoding cost, typically a rate-distortion cost, of the residual motion information. The residual motion information comprises the residual motion vector, i.e. the difference between the actual motion vector of the block to encode and the selected motion vector predictor, and an item of information indicating the selected motion vector predictor, such as for example an encoded value of the index of the selected motion vector predictor.

In the High Efficiency Video Coding (HEVC) currently in the course of standardization, it has been proposed to use a plurality of motion vector predictors as schematically illustrated in FIG. 1: 3 so-called spatial motion vector predictors V₁, V₂ and V₃ taken from blocks situated in the neighbourhood of the block to encode, a median motion vector predictor computed based on the components of the three spatial motion vector predictors V₁, V₂ and V₃ and a temporal motion vector predictor V₀ which is the motion vector of the co-located block in a previous image of the sequence (e. g. block of image N−1 located at the same spatial position as block ‘Being coded’ of image N). Currently in HEVC the 3 spatial motion vector predictors are taken from the block situated to the left of the block to encode (V₃), the block situated above (V₂) and from one of the blocks situated at the respective corners of the block to encode, according to a predetermined rule of availability. This motion vector predictor selection scheme is called Advanced Motion Vector Prediction (AMVP). In the example of FIG. 1, the vector V₁ of the block situated above left is selected.

Finally, a set of 5 motion vector predictor candidates mixing spatial predictors and temporal predictors is obtained. In order to reduce the overhead of signaling the motion vector predictor in the bitstream, the set of motion vector predictors is reduced by eliminating the duplicated motion vectors, i.e. the motion vectors which have the same value. For example, in the illustration of FIG. 1, V₁ and V₂ are equal, and V₀ and V₃ are also equal, so only two of them should be kept as a motion vector prediction candidate, for example V₀ and V₁. In this case, only one bit is necessary to indicate the index of the motion vector predictor to the decoder.

A further reduction of the set of motion vector predictors, based on the values of the predictors, is possible. Once the best motion vector predictor is selected and the motion vector residual is computed, it is possible to further eliminate from the prediction set the candidates which would have not been selected, knowing the motion vector residual and the cost optimization criterion of the encoder. A sufficient reduction of the set of predictors leads to a gain in the signaling overhead, since the indication of the selected motion vector predictor can be encoded using fewer bits. At the limit, the set of candidates can be reduced to 1, for example if all motion vector predictors are equal, and therefore it is not necessary to insert any information relative to the selected motion vector predictor in the bitstream.

To summarize, the encoding of motion vectors by difference with a motion vector predictor, along with the reduction of the number of motion vector predictor candidates leads to a compression gain. However, as explained above, for a given block to encode, the reduction of the number of motion vector predictor candidates is based on the values taken by the motion vector predictors of the set, in particular the values of the motion vectors of the neighbouring blocks and of the motion vector of the co-located block. Also, the decoder needs to be able to apply the same analysis of the set of possible motion vector predictors as the encoder, in order to deduce the amount of bits used for indicating the selected motion vector predictor and to be able to decode the index of the motion vector predictor and finally to decode the motion vector using the motion vector residual received. Referring to the example of FIG. 1, the set of motion vector predictors of the block ‘being coded’ is reduced by the encoder to V₀ and V₁, so the index is encoded on 1 single bit. If the block of image N−1 is lost during transmission, the decoder cannot obtain the value of V₀, and therefore cannot find out that V₀ and V₃ are equal. Therefore, the decoder cannot find how many bits were used for encoding the index of the motion vector predictor for the block ‘being coded’, and consequently the decoder cannot correctly parse the data for the slice because it cannot find where the index encoding stops and the encoding of video data starts.

Therefore, the fact that the number of bits used for signaling the motion vector predictors depends of the values taken by the motion vector predictors makes the method very vulnerable to transmission errors, when the bitstream is transmitted to a decoder on a lossy communication network. Indeed, the method requires the knowledge of the values of the motion vector predictors to parse the bitstream correctly at the decoder. In case of packet losses, when some motion vector residual values are lost, it is impossible for the decoder to determine how many bits were used to encode an index representing the motion vector predictor has been encoded, and so it is impossible to parse the bitstream correctly. Such an error may propagate causing the decoder's de-synchronization until a following synchronization image, encoded without prediction, is received by the decoder.

It would be desirable to at least be able to parse an encoded bitstream at a decoder even in case of packet losses, so that some re-synchronization or error concealment can be subsequently applied.

It was proposed, in the document JCTVC-C166r1, ‘TE11: Study on motion vector coding (experiment 3.3a and 3.3c)’ by K. Sato, published at the 3^{rd} meeting of the Joint Collaborative Team on Video Coding (JTC-VC) of Guangzhou, 7-15 of Oct. 2010, to use only the spatial motion vector predictors coming from the same slice in the predictor set. This solution solves the problem of parsing at the decoder in case of slice losses. However, the coding efficiency is significantly decreased, since the temporal motion vector predictor is no longer used. Therefore, this solution is not satisfying in terms of compression performance.

Document JCTVC-C257, ‘On motion vector competition’, by Yeping Su and Andrew Segall, published at the 3^{rd} meeting of the Joint Collaborative Team on Video Coding (JTC-VC) of Guangzhou, 7-15 of Oct. 2010, proposes signaling separately if the selected motion vector predictor is the temporal predictor, i.e. the motion vector of the co-located block, and, if the selected motion vector predictor is not the temporal predictor, using the scheme described above to indicate the selected candidate. However, this proposal fails to achieve the result of ensuring correct parsing at the decoder in some cases. Indeed, it assumes that the spatial motion vector predictors are necessarily known at the decoder. However, a motion vector of a neighbouring block of the block to encode may itself be predicted from a temporal co-located block which has been lost during transmission. In that case, the value of a motion vector of the set of predictors is unknown, and the parsing problem at the decoder occurs.

### BRIEF SUMMARY OF THE INVENTION

It is desirable to address one or more of the prior art drawbacks. It is also desirable to provide a method allowing correct parsing at the decoder even in the case of a bitstream corrupted by transmission losses while keeping good compression efficiency.

To that end, the invention relates to method of encoding a sequence of digital images into a plurality of encoding units forming a bitstream to be provided to a decoder, at least one portion of an image being encoded by motion compensation with respect to a reference image portion indicated by an item of motion information, comprising determining a motion information predictor among a set of motion information predictors and encoding said item of motion information with respect to said motion information predictor. The method comprises determining whether to use a first encoding mode or a second encoding mode for the motion information predictors of at least one said encoding unit.

Preferably, the method further comprises signaling in the bitstream the determined encoding mode for the motion information predictors in association with said encoding unit.

Preferably, the second encoding mode provides encoded data that can be systematically parsed by said decoder, even in case of losses in the bitstream.

In one embodiment, the first encoding mode compresses the motion vector predictors more than the second encoding mode.

For example, the first encoding mode may be dependent on the number of motion vector predictors in the set of predictors, whereas the second encoding mode may be independent of the number of motion vector predictors in the set of predictors. This means that encoded data, for example a motion vector predictor index, of the first encoding mode can be compact (e.g. 1 bit), but is not parseable in the event of loss or corruption of data in the bitstream. Encoded data of the second encoding mode is less compact (e.g. index ‘i’ may be i+1 bits) but is parseable even in the event of loss or corruption of data in the bitstream.

In one embodiment the first encoding mode may be entropy encoding, and the second encoding mode may be prefix encoding. The prefix encoding may be unary encoding.

In another embodiment one or both encoding modes involve excluding one or more motion information predictors from the set of motion information predictors. This can enable the number of motion information predictors to be reduced. This in turn enables compression of the encoded data, e.g. the motion vector predictor index.

For example, the first encoding mode may involve exclusion of motion information predictors but the second encoding mode may involve excluding no motion information predictors or fewer motion information predictors than the first encoding mode.

Alternatively, both the first and encoding modes may involve such exclusion. Even in this case, encoded data of the second encoding mode is still parseable in the event of losses or corruption in the bitstream provided that suitable encoding (e.g. encoding independent of the number of motion vector predictors in the set of predictors) is used in the second encoding mode.

In one embodiment the number of motion information predictors used in the first encoding mode is variable but the number of motion information predictors used in the second encoding mode is invariable. In this case, compression-efficient encoding such as entropy encoding may be used in both encoding modes. If errors occur or there is corruption in the bitstream then encoded data of the first encoding mode is not parseable reliably but encoded data of the second encoding mode is still parseable reliably.

In another embodiment the number of motion information predictors used in both the first and second encoding modes is variable. In this case, compression-efficient encoding such as entropy encoding may be used in the first encoding mode but other encoding (e.g. encoding independent of the number of motion vector predictors in the set of predictors such a prefix or unary encoding) should be used in the second encoding mode. If errors occur or there is corruption in the bitstream then encoded data of the first encoding mode is not parseable reliably but encoded data of the second encoding mode is still parseable reliably.

Advantageously, the motion information can be represented by motion vectors.

As described above, in an encoding method embodying the invention the first encoding mode is a compression efficient encoding mode, but provides first encoded data in which the decoder cannot parse the information relative to the motion information predictors in case of losses or corruption in the bitstream, whereas the second encoding mode is less efficient in terms of compression, but provides second encoded data which is systematically parseable by a decoder in case of losses or corruption in the bitstream.

The selection of one of the two modes can be applied at the level of an encoding unit, for example for a slice of a digital image, based on a criterion taking into account various parameters, such as the contents of the sequence of images and/or the transmission conditions on the communication network. Therefore, an encoding method embodying the invention can advantageously select between a first compression efficient mode and a second mode which facilitates the decoder error resilience in case of losses in the bitstream.

According to another aspect, the invention relates to a method of encoding a sequence of digital images into a plurality of encoding units forming a bitstream, at least one block of an image being encoded by motion compensation with respect to a reference block indicated by a motion vector, comprising selecting a motion vector predictor among a set of motion vector predictors and also comprising encoding an index of said selected motion vector predictor and a difference between said motion vector and said selected motion vector predictor. For at least one said encoding unit, the method comprises the steps of:
determining whether or not to apply, for each block of said encoding unit, a reduction of said set of motion vector predictors, said reduction being based, for each said block, on the actual values taken by the motion vector predictors for said block, and
inserting in the bitstream in association with said encoding unit a flag indicating a result of the determining step.

Advantageously, the encoding units are slices which are formed from several image blocks.

According to yet another aspect, the invention relates to a method of encoding a sequence of digital images into a plurality of encoding units forming a bitstream, at least one block of an image being encoded by motion compensation with respect to a reference block indicated by a motion vector, comprising selecting a motion vector predictor among a set of motion vector predictors and also comprising encoding an index of said selected motion vector predictor. For at least one said encoding unit, the method comprises the steps of:
determining whether or not to apply, for each block of said encoding unit, an encoding method of the index of the motion vector predictor selected for said block which enables encoded data of said encoding unit to be systematically parsed by a decoder even in case of losses, and
inserting in the bitstream in association with said encoding unit a flag indicating a result of the determining step.

According to yet another aspect, the invention relates to a device for encoding a sequence of digital images into a plurality of encoding units forming a bitstream to be provided to a decoder, at least one portion of an image being encoded by motion compensation with respect to a reference image portion indicated by an item of motion information, the device comprising means for determining a motion information predictor among a set of motion information predictors and means encoding said item of motion information with respect to said motion information predictor. The device further comprises means for determining whether to use a first encoding mode or a second encoding mode for the motion information predictors of at least one said encoding unit.

Preferably, the device further comprises means for signaling in the bitstream said determined encoding mode for the motion information predictors in association with said encoding unit.

Preferably the second encoding mode provides encoded data that can be systematically parsed by said decoder, even in case of losses in the bitstream.

According to yet another aspect, the invention also relates to an information storage means that can be read by a computer or a microprocessor, this storage means being removable, and storing instructions of a computer program for the implementation of the method for encoding a sequence of digital images as briefly described above.

According to yet another aspect, the invention also relates to a computer program product that can be loaded into a programmable apparatus, comprising sequences of instructions for implementing a method for encoding a sequence of digital images as briefly described above, when the program is loaded into and executed by the programmable apparatus. Such a computer program may be transitory or non transitory. In an implementation, the computer program can be stored on a non-transitory computer-readable carrier medium.

The particular characteristics and advantages of the device for encoding a sequence of digital images, of the storage means and of the computer program product being similar to those of the digital video signal encoding method, they are not repeated here.

According to yet another aspect, the invention also relates to a method for decoding a bitstream comprising an encoded sequence of digital images, the bitstream comprising a plurality of encoding units, at least one portion of an image being encoded by motion compensation with respect to a reference image portion indicated by an item of motion information, said item of motion information being encoded with respect to a motion information predictor selected among a set of motion information predictors. The method comprises, for at least one said encoding unit, the steps of:
determining whether an encoding mode for the motion information predictors is a first encoding mode or a second encoding mode, and
applying, according to the determined encoding mode, one of first and second decoding modes, corresponding respectively to said first and second encoding modes, to decode the motion information predictor of said encoding unit.

Preferably, the encoding mode is determined by obtaining from the bitstream an item of information indicating whether the encoding mode for the motion information predictors is the first encoding mode or the second encoding mode, and the first or second decoding mode is applied according to the obtained item of information.

Preferably, the second encoding mode provides encoded data that can be systematically parsed, even in case of losses in the bitstream,

The method for decoding a bitstream has the advantage of using either a first or a second decoding method for the motion information predictors, each being applied to an encoding unit as specified in the bitstream. Advantageously, the second decoding method is selected so that the received items of information relative to the motion information predictors can be parsed even in the case of losses or corruption in the bitstream.

According to yet another aspect, the invention also relates to a method for decoding a bitstream comprising an encoded sequence of digital images, the bitstream comprising a plurality of encoding units, at least one block of an image being encoded by motion compensation with respect to a reference block indicated by an item of motion information, the encoding comprising selecting a motion vector predictor among a set of motion information predictors and also comprising encoding an index of the selected motion vector predictor and a difference between said motion vector and said selected motion vector predictor. The encoding further comprises determining whether or not to apply, for each block of said encoding unit, a reduction of said set of motion vector predictors, said reduction being based, for each said block, on the actual values taken by the motion vector predictors for said block, and inserting in the bitstream in association with said encoding unit a flag indicating whether or not said reduction has been applied. The decoding method comprises, for at least one said encoding unit, the steps of:
obtaining said flag from the bitstream, and
applying, according to the obtained flag, one of first and second decoding modes, to decode the motion vector predictor of said encoding unit, the first decoding mode being applied when the obtained flag indicates that said reduction has been applied and the second decoding .mode being applied when the obtained flag indicates that said reduction has not been applied.

Preferably, the second encoding mode provides encoded data that can be systematically parsed, even in case of losses in the bitstream,

According to yet another aspect, the invention also relates to a method for decoding a bitstream comprising an encoded sequence of digital images, the bitstream comprising a plurality of encoding units, at least one block of an image being encoded by motion compensation with respect to a reference block indicated by an item of motion information, the encoding comprising selecting a motion vector predictor among a set of motion information predictors and also comprising encoding an index of the selected motion vector predictor and a difference between said motion vector and said selected motion vector predictor. The encoding further comprises determining whether or not to apply, for each block of said encoding unit, an encoding method of the index of motion vector predictor selected for the block which enables encoded data of the block to be systematically parsed even in case of losses, and inserting in the bitstream in association with said encoding unit a flag indicating whether or not the systematically-parseable encoding method has been applied. The decoding method comprises, for at least one said encoding unit, the steps of:
obtaining said flag from the bitstream, and
applying, according to the obtained flag, one of first and second decoding modes, to decode the motion vector predictor of said encoding unit, the first decoding mode being applied when the obtained flag indicates that said systematically-parseable encoding method has not been applied and the second decoding .mode being applied when the obtained flag indicates that said systemically-parseable encoding method has not been applied.

Preferably, the second encoding mode provides encoded data that can be systematically parsed, even in case of losses in the bitstream,

According to yet another aspect, the invention also relates to a device for decoding a bitstream comprising an encoded sequence of digital images, the bitstream comprising a plurality of encoding units, at least one portion of an image being encoded by motion compensation with respect to a reference image portion indicated by an item of motion information, said item of motion information being encoded with respect to a motion information predictor selected among a set of motion information predictors. The decoding device comprises, to apply for at least one said encoding unit,
means for determining whether an encoding mode for the motion information predictors is a first encoding mode or a second encoding mode, and
means for applying, according to the determined encoding mode, one of first and second decoding modes, corresponding respectively to said first and second encoding modes, to decode the motion information predictor of said encoding unit.

Preferably, the determining means obtains from the bitstream an item of information indicating whether the encoding mode for the motion information predictors is the first encoding mode or the second encoding mode, and the applying means applies the first or second decoding mode according to the obtained item of information.

Preferably, the second encoding mode provides encoded data that can be systematically parsed by said decoder, even in case of losses in the bitstream,

According to yet another aspect, the invention also relates to an information storage means that can be read by a computer or a microprocessor, this storage means being removable, and storing instructions of a computer program for the implementation of the method for decoding a bitstream as briefly described above.

According to yet another aspect, the invention also relates to a computer program product that can be loaded into a programmable apparatus, comprising sequences of instructions for implementing a method for decoding a bitstream as briefly described above, when the program is loaded into and executed by the programmable apparatus. Such a computer program may be transitory or non transitory. In an implementation, the computer program can be stored on a non-transitory computer-readable carrier medium.

The particular characteristics and advantages of the device for decoding a bitstream, of the storage means and of the computer program product being similar to those of the decoding method, they are not repeated here.

According to yet another aspect, the invention relates to a bitstream comprising an encoded sequence of digital images, the bistream comprising a plurality of encoding units, at least one portion of an image being encoded by motion compensation with respect to a reference image portion indicated by an item of motion information, said item of motion information being encoded with respect to a motion information predictor selected among a set of motion information predictors. The bitstream comprises, for at least one said encoding unit, an item of information indicating whether an encoding mode for the motion information predictors of said encoding unit is a first encoding mode or a second encoding mode.

Preferably, the second encoding mode provides encoded data that can be systematically parsed by a decoder, even in case of losses in the bitstream.

### BRIEF DESCRIPTION OF THE DRAWINGS

Other features and advantages will appear in the following description, which is given solely by way of non-limiting example and made with reference to the accompanying drawings, in which:

FIG. 1, already described, illustrates schematically a set of motion vector predictors used in a motion vector prediction scheme;

FIG. 2 is a diagram of a processing device adapted to implement an embodiment of the present invention;

FIG. 3 is a block diagram of an encoder according to an embodiment of the invention;

FIGS. 4A and 4B are block diagrams detailing embodiments of the motion vector prediction and coding;

FIG. 5 details an embodiment of the module of determination of an encoding mode for the motion vector predictors;

FIG. 6 represents schematically a plurality of image slices;

FIG. 7 represents schematically a hierarchical temporal organization of a group of images;

FIG. 8 illustrates a block diagram of a decoder according to an embodiment of the invention, and

FIG. 9 illustrates an embodiment of the motion vector decoding of FIG. 8.

### DETAILED DESCRIPTION OF THE EMBODIMENTS

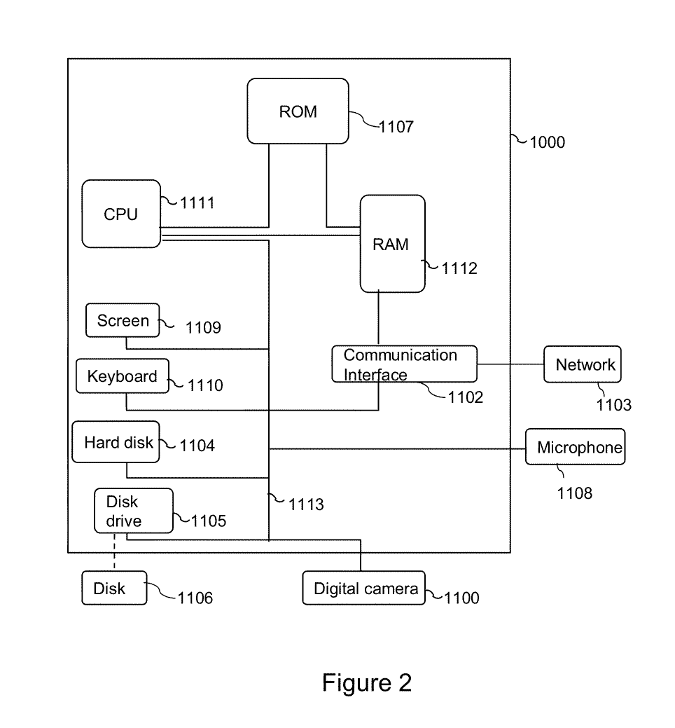

FIG. 2 illustrates a diagram of a processing device 1000 adapted to implement one embodiment of the present invention. The apparatus 1000 is for example a micro-computer, a workstation or a light portable device.

The apparatus 1000 comprises a communication bus 1113 to which there are preferably connected:
a central processing unit 1111, such as a microprocessor, denoted CPU;
a read only memory 1107 able to contain computer programs for implementing the invention, denoted ROM;
a random access memory 1112, denoted RAM, able to contain the executable code of the method of the invention as well as the registers adapted to record variables and parameters necessary for implementing the method of encoding a sequence of digital images; and
a communication interface 1102 connected to a communication network 1103 over which digital data to be processed are transmitted.

Optionally, the apparatus 1000 may also have the following components:
a data storage means 1104 such as a hard disk, able to contain the programs implementing the invention and data used or produced during the implementation of the invention;
a disk drive 1105 for a disk 1106, the disk drive being adapted to read data from the disk 1106 or to write data onto said disk;
a screen 1109 for displaying data and/or serving as a graphical interface with the user, by means of a keyboard 1110 or any other pointing means.

The apparatus 1000 can be connected to various peripherals, such as for example a digital camera 1100 or a microphone 1108, each being connected to an input/output card (not shown) so as to supply multimedia data to the apparatus 1000.

The communication bus affords communication and interoperability between the various elements included in the apparatus 1000 or connected to it. The representation of the bus is not limiting and in particular the central processing unit is able to communicate instructions to any element of the apparatus 1000 directly or by means of another element of the apparatus 1000.

The disk 1106 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables the method of encoding a sequence of digital images and/or the method of decoding a bitstream according to the invention to be implemented.

The executable code may be stored either in read only memory 1107, on the hard disk 1104 or on a removable digital medium such as for example a disk 1106 as described previously. According to a variant, the executable code of the programs can be received by means of the communication network, via the interface 1102, in order to be stored in one of the storage means of the apparatus 1000 before being executed, such as the hard disk 1104.

The central processing unit 1111 is adapted to control and direct the execution of the instructions or portions of software code of the program or programs according to the invention, instructions that are stored in one of the aforementioned storage means. On powering up, the program or programs that are stored in a non-volatile memory, for example on the hard disk 1104 or in the read only memory 1107, are transferred into the random access memory 1112, which then contains the executable code of the program or programs, as well as registers for storing the variables and parameters necessary for implementing the invention.

In this embodiment, the apparatus is a programmable apparatus which uses software to implement the invention. However, alternatively, the present invention may be implemented in hardware (for example, in the form of an Application Specific Integrated Circuit or ASIC).

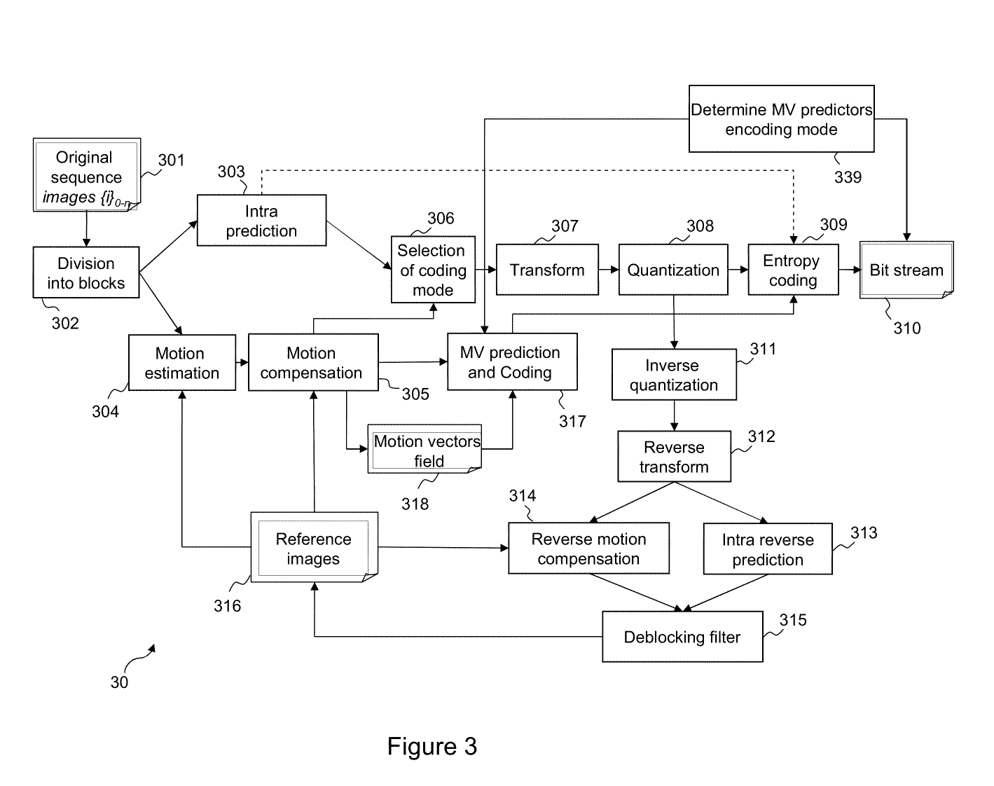

FIG. 3 illustrates a block diagram of an encoder according to a first embodiment of the invention. The encoder is represented by connected modules, each module being adapted to implement, for example in the form of programming instructions to be executed by the CPU 1111 of device 1000, a corresponding step of a method implementing an embodiment of the invention.

An original sequence of digital images i₀ to iₙ 301 is received as an input by the encoder 30. Each digital image is represented by a set of samples, known as pixels.

The input digital images are divided into blocks (302), which blocks are image portions. A coding mode is selected for each input block. There are two families of coding modes, spatial prediction coding or Intra coding, and temporal prediction (Inter) coding. The possible coding modes are tested.

Module 303 implements Intra prediction, in which the given block to encode is predicted by a predictor computed from pixels in its neighbourhood. An indication of the

Intra predictor selected and the difference between the given block and its predictor is encoded if the Intra prediction is selected.

Temporal prediction is implemented by modules 304 and 305. Firstly a reference image among a possible set of reference images 316 is selected, and a portion of the reference image, also called reference area, which is the closest area to the given block to encode, is selected by the motion estimation module 304. The difference between the selected reference area and the given block, also called a residual block, is computed by the motion compensation module 305. The selected reference area is indicated by a motion vector. An information relative to the motion vector and the residual block is encoded if the Inter prediction is selected. To further reduce the bitrate, the motion vector is encoded by difference with respect to a motion vector predictor. A set of motion vector predictors, also called motion information predictors, is obtained from the motion vectors field 318 by a motion vector prediction and coding module 317.

Advantageously, the motion vector prediction and coding module is monitored by module 339 which switches the motion vector predictor encoding mode between a first encoding mode, which is more efficient in terms of compression but for which the information on the motion vector predictor cannot be parsed by a decoder in case of losses, and a second encoding mode, which is less efficient in terms of compression but for which the information on the motion vector predictor can be parsed by a decoder even in case of losses during transmission.

In the first embodiment, module 339 decides whether or not to apply a reduction of the set of motion vector predictors.

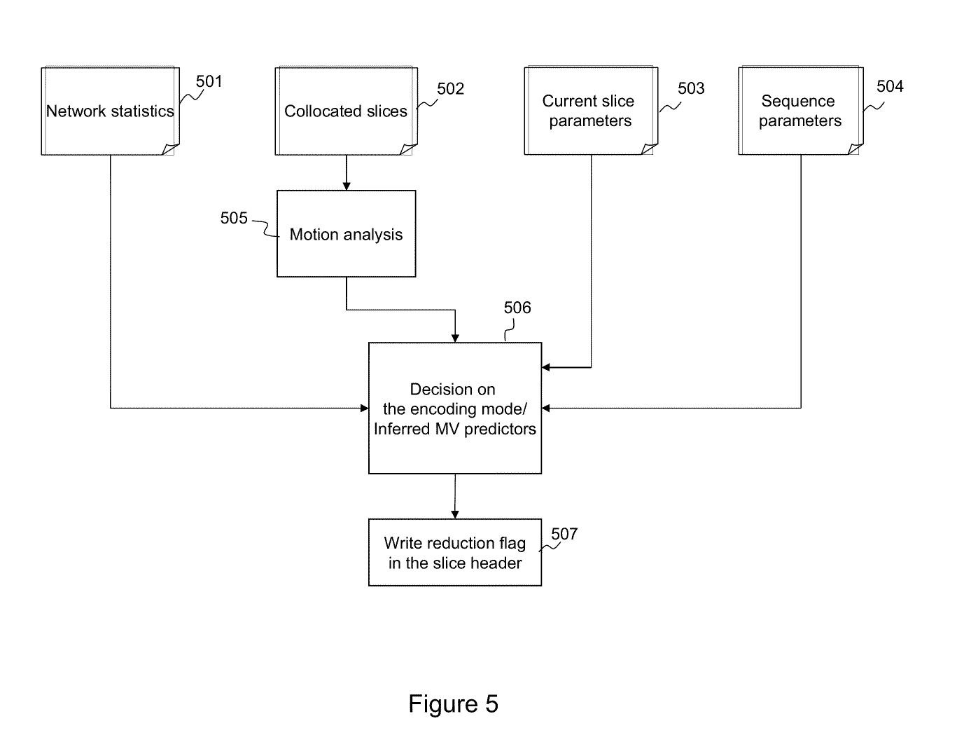

As explained hereafter in detail with respect to FIG. 5, the decision of module 339 is taken with respect to a criterion based on an analysis of the content of the video sequence and/or on the network conditions in the case where the encoded video sequence is intended to be sent to a decoder via a communication network.

The decision on the selection of an encoding mode for the motion vector predictors is applied at the level of a coding unit, a coding unit being either a slice or the entire sequence or a group of images of the sequence. An item of information indicating whether or not the reduction process is applied, typically a binary flag, is then inserted in the bitstream 310, for example within the header of the coding unit considered. For example, if the determination is applied at the slice level, a flag is inserted in the slice header.

In the first embodiment, the application of the reduction process on the set of motion vector predictors affects the number of bits used by the entropic coding module 309 to encode the motion vectors of the blocks of the considered coding unit.

The encoder 30 further comprises a module of selection of the coding mode 306, which uses an encoding cost criterion, such as a rate-distortion criterion, to determine which is the best mode among the spatial prediction mode and the temporal prediction mode. A transform 307 is applied to the residual block, the transformed data obtained is then quantized by module 308 and entropy encoded by module 309. Finally, the encoded residual block of the current block to encode is inserted in the bitstream 310, along with the information relative to the predictor used. For the blocks encoded in ‘SKIP’ mode, only a reference to the predictor is encoded in the bitstream, without residual.

The encoder 30 further performs the decoding of the encoded image in order to produce a reference image for the motion estimation of the subsequent images. The module 311 performs inverse quantization of the quantized data, followed by an inverse transform 312. The reverse motion prediction module 313 uses the prediction information to determine which predictor to use for a given block and the reverse motion compensation module 314 actually adds the residual obtained by module 312 to the reference area obtained from the set of reference images 316. Optionally, a deblocking filter 315 is applied to remove the blocking effects and enhance the visual quality of the decoded image. The same deblocking filter is applied at the decoder, so that, if there is no transmission loss, the encoder and the decoder apply the same processing.

Alternatively, in a second embodiment, the reduction of the set of motion vector predictors is applied systematically, but the encoding of the index of a motion vector predictor is either an entropy encoding in the first encoding mode or a unary type encoding in the second encoding mode. More generally, entropy coding is an efficient coding which is dependent on the number of motion vector predictors in the set of predictors, whereas unary is a less efficient encoding which is independent of the number of motion vector predictors in the set of predictors and can be systematically decoded. The decision of module 339 results in applying either an entropy encoding or a unary encoding on the index of the motion vector predictor.

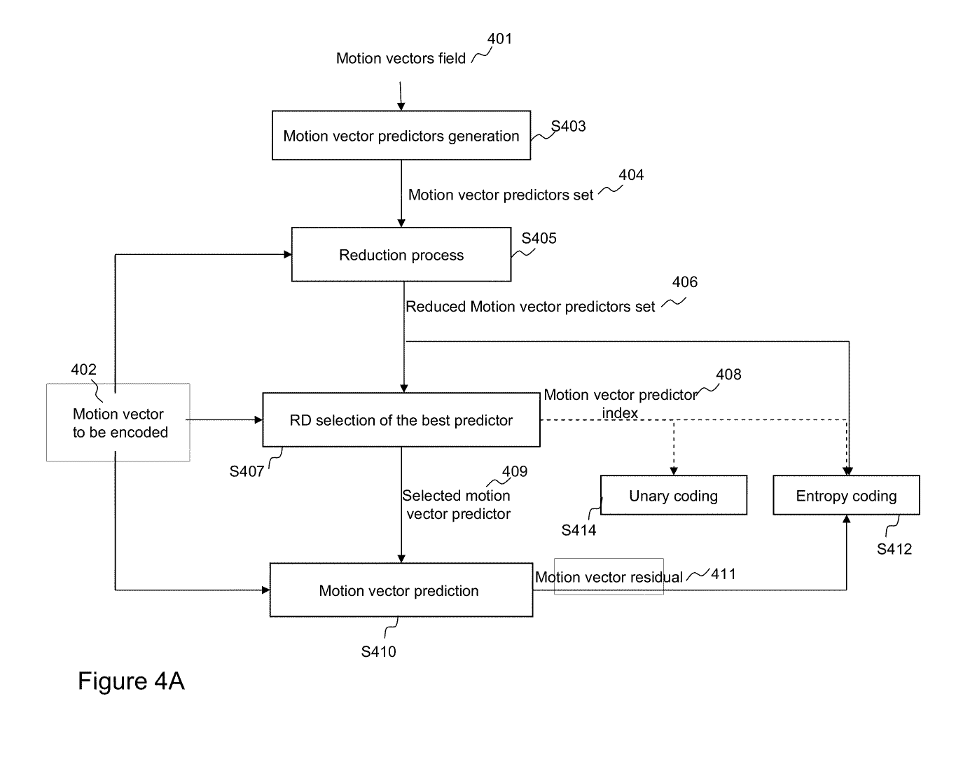

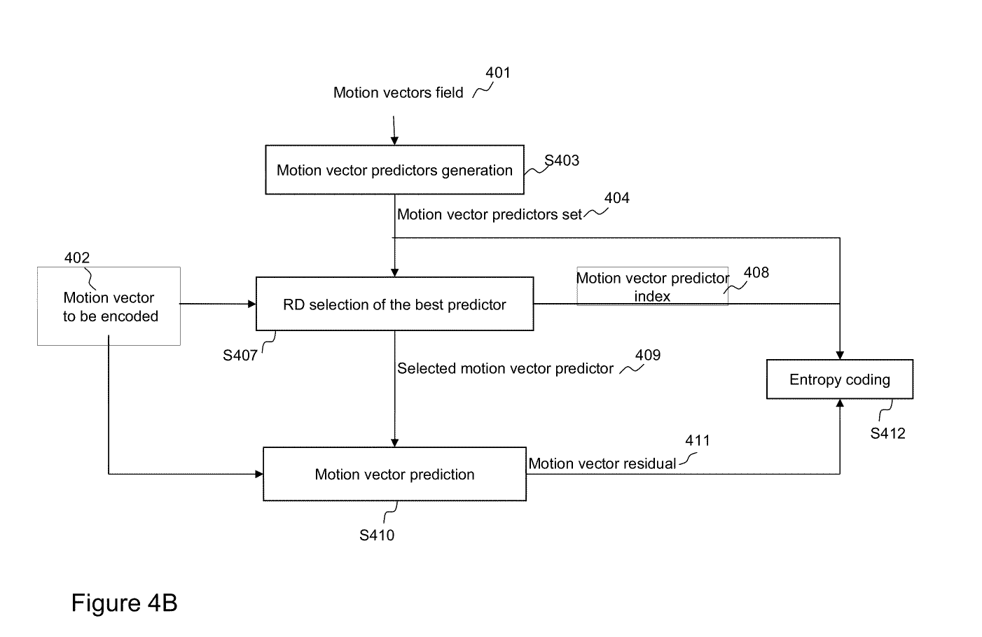

FIG. 4A details the embodiment of the motion vector prediction and coding (module 317 of FIG. 3) when the process of reduction of the set of motion vector predictors is applied. All the steps of the algorithm represented in FIG. 4A can be implemented in software and executed by the central processing unit 1111 of the device 1000.

The motion vector prediction and coding module 317 receives as one input a motion vectors field 401, comprising the motion vectors computed for the blocks of the digital images previously encoded and decoded. These motion vectors are used as a reference. The module 317 also receives as a further input the motion vector to be encoded 402 of the current block being processed.

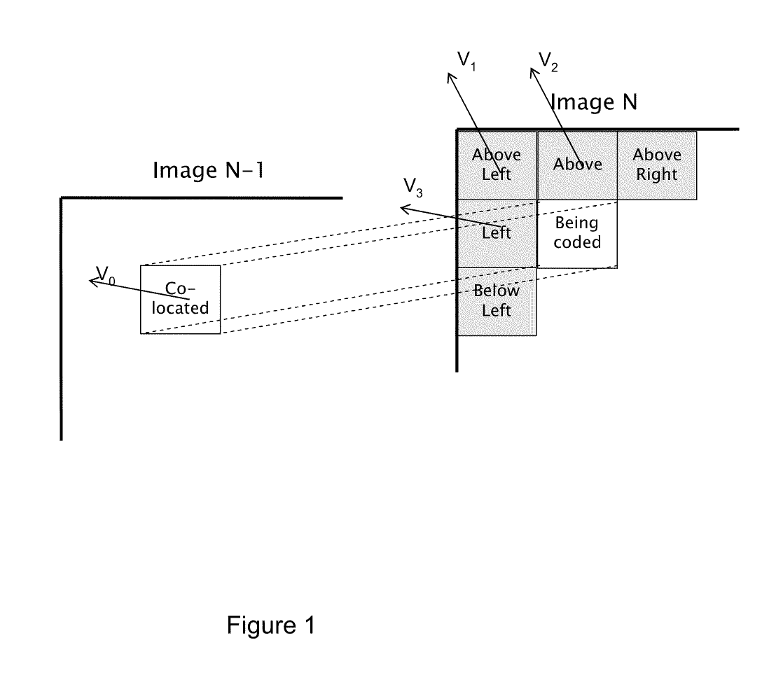

In step S403, a set of motion vector predictors 404 is obtained. This set contains a predetermined number of motion vector predictors, for example the motion vectors of the blocks in the neighbourhood of the current block, as illustrated in FIG. 1 and the motion vector of the co-located block in the reference image.

Typically, a form of prediction called advanced motion vector prediction (AMVP) is used. Alternatively, any scheme for selecting motion vectors already computed and computing other motion vectors from available ones (i.e. average, median etc) to form the set of motion vector predictors 404 can be applied.

The reduction process applied in step S405 analyses the values of the motion vector predictors of the set 404, and eliminates duplicates, to produce a reduced motion vector predictors set 406. A selection of the best predictor for the motion vector to be encoded 402 is applied in step S407, typically using a rate-distortion criterion. A motion vector predictor index 408 is then obtained. In some particular cases the reduced motion vector predictors set 406 contains only one motion vector, in which case the index is implicitly known. In all cases, the maximum number of bits necessary to encode the motion vector predictor index 408 depends on the number of items in the reduced motion vector predictors set 406, and this number depends on the values taken by the motion vectors of the motion vectors set 404.

The difference between the motion vector to encode 402 and the selected motion vector predictor 409 is computed in step S410 to obtain a motion vector residual 411.

In an embodiment, the motion vector residual 411 and the motion vector predictor index 408 within the reduced set of motion vector predictors 406 are entropy encoded in step S412.

In an alternative embodiment, when the second encoding mode is selected by module 339 of FIG. 3, the motion vector residual 411 is encoded by entropy encoding in step S412, whereas the motion vector predictor index among the reduced set of motion vector predictors 406 is encoded by a different encoder in step S414, such as a unary encoder, which provides a code that can be parsed at the decoder even if there are some losses and if the size and contents of the reduced set of motion vector predictors 406 cannot be obtained by a decoder. More generally, entropy encoding optimizes the size of the encoded index taking into account the number of vectors in the reduced motion vector predictors set 406, whereas unary encoding encodes the motion vector index without taking into account the number of vectors in the reduced motion vector predictors set 406.

Typically, a unary code is a code that, given an index value, encodes a number of ‘1’s equal to the index value followed by a ‘0’. For example, value 2 would be encoded as ‘110’ and value 4 as ‘11110’.

Obviously, other encoding alternatives (e.g. a fixed number of ‘0’s followed by a ‘1’) can be used, as far as the code can be correctly parsed by a decoder. More generally, a unary code is called a prefix code. A number encoded by such a prefix code can be systematically decoded, independently of the number of data to be encoded, since for example the index value 2 would be encoded as ‘110’ whatever the number of vectors in the number of vectors in the reduced motion vector predictors set 406.

Therefore, a prefix type code has the advantage of being parseable, but is not advantageous in terms of compression efficiency.

FIG. 4B details the embodiment of the motion vector prediction and coding (module 317 of FIG. 3) when the process of reduction of the set of motion vector predictors is not applied. In FIG. 4B, steps and data which are the same as, or correspond to, the steps and data described with reference to FIG. 4A have the same reference numbers.

As apparent from FIG. 4B, the motion vector prediction and coding is simpler and comprises a subset of the steps of the steps illustrated in FIG. 4A.

In short, the best motion vector predictor for the motion vector to be coded 402 is selected from the motion vector predictors set 404. Compared to the case where the reduction process is applied, the number of vectors in the motion vector predictors set 404 is fixed and can be known at the decoder without any computation based on the values of the motion vectors from the motion vector field.

FIG. 5 details an embodiment of the module 339 of determining an encoding mode for the motion vector predictors (module 339 of FIG. 3). All the steps of the algorithm represented in FIG. 5 can be implemented in software and executed by the central processing unit 1111 of the device 1000.

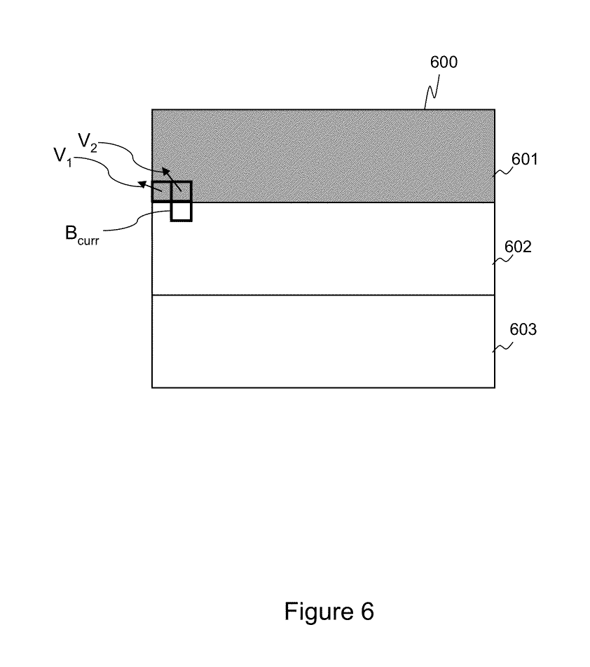

In this embodiment the encoding unit of the bitstream processed is a slice, but, as mentioned above, the present invention is not limited to this, and other encoding units can be processed. A digital image of the sequence can be partitioned into several slices, as illustrated in FIG. 6, in which an image 600 is divided into three spatial slices 601, 602 and 603.

The determination of an encoding mode for the motion vector predictors, applied for a current slice, takes into account network statistics 501 and/or a content analysis of the sequence of digital images 505 and/or an encoding parameter of the current slice 503 and/or the sequence encoding parameters 504.

The network statistics 501 comprise the probability of packet loss in the communication network, which can be received by the encoder either as a feedback from the decoder, or can be computed directly at the encoder. Typically, if the probability of packet loss is low, for example equal to 0.000001, the module 506 decides to use the first encoding mode, which is more efficient in terms of rate-distortion compromise. In the first embodiment, when the probability of packet loss is low, the first encoding mode, that is to say the process of reduction of the set of motion vector predictors, is applied. Otherwise, if the probability of packet loss is high, the second encoding mode, which ensures the possibility of parsing at the decoder even in case of loss, is applied. More generally, if the probability of packet loss is high, the second encoding mode is applied, so that the bitstream can be parsed at the decoder even in case of losses. On the contrary, if the probability of packet loss is low, the first encoding mode is applied.

The use of error protection mechanisms, such as Forward Error Correction codes (FEC), can also be taken into account to adjust the decision of module 506. Typically, if many FECs are inserted in the bitstream, the first encoding mode should be applied.

Finally, if a feedback channel mechanism is applied, the encoder can use the information of slices already received by the decoder. For example, when a slice is received by the decoder, the reduction process can be applied for the slice located at the same spatial position (called the co-located slice) in the following image of the sequence.

The determination of an encoding mode for the motion vector predictors, applied for a current slice, can also use a content analysis. In particular, the slices located at the same spatial position as the current slice 502 in a given number of previous frames can be used to analyze the motion content (505) of the current slice.

In an alternative embodiment, the motion analysis can be applied on the current slice, encoded during a first encoding pass. The encoding mode is then selected by the module 506. If this module selects the second encoding mode then the current slice is encoded in a second encoding pass.

The motion analysis module 505 computes, for the plurality of slices 502 considered, the absolute average vector V^{a} (vₓ, v_{y}) of all the motion vectors considered (wherein vₓ and v_{y} are the components defining vector V^{a}) and the maximum absolute value for each component (vₓₘₐₓ, v_{ymax}) of all the motion vectors considered.

These values are compared to predetermined thresholds. If both the absolute average and the maximum absolute components are considered to be low, than the corresponding slice is likely to contain a static area with little motion activity. In this case, the first encoding mode of the motion vector predictors can be applied to the current slice. For example, the motion activity is considered to be low if the absolute average value of each component is less than 2 and the maximum absolute value for each component is than 4. In case of slice loss, the decoder cannot parse the data corresponding to the motion vector prediction. As a consequence, the co-located slice is likely to be frozen until the following Intra refresh image (IDR) which is encoded without temporal dependencies. However, based on the result of the motion analysis, it can be assumed that there is no visual impact if a slice with very little motion activity remains frozen. Further, the optimized encoding of the motion vector predictors brings a large improvement in the case of static areas, where motion vectors of a neighbourhood are likely to be very similar, and so a large gain in terms of encoding rate can be expected.

On the contrary, if either the average absolute motion vector or the maximum absolute components are found to be significant, i.e. of value higher than predetermined thresholds, than the slice is likely to contain some motion. In this case, module 506 decides to apply the second encoding mode which guarantees correct parsing at the decoder. Indeed, for slices containing moving objects, the loss of a co-located slice would have a large impact on the visual quality if a freeze occurs.

Considering the example of FIG. 6, if for slice 601 the average absolute vector is equal to V^{a}(0,0) and the respective maximum absolute values are (1,2), then the slice is considered as static. If for slice 602 the respective values are V^{a} (3,3) for the average absolute vector and (16,16) for the maximum absolute components, the slice 602 is considered as containing motion. Further, if for slice 603 the respective values are V^{a}(0,0) for the average absolute vector and (5,6) for the maximum absolute components, the slice is considered as containing motion.

In an alternative embodiment, a decision may be taken by simply using the average motion vector compared to a given threshold.

An encoding parameter or characteristic 503 such as the number of Intra encoded blocks in a given slice can also be used by the decision module 506: if the slice contains a large number of Intra blocks, the second encoding mode is preferable because the possible parsing of the slice at the decoder can largely enhance the visual quality in case of losses.

The determination of an encoding mode for the motion vector predictors, applied for a current slice, can also use more generally some encoding characteristics 503 of the current slice to encode or sequence encoding parameters 504.

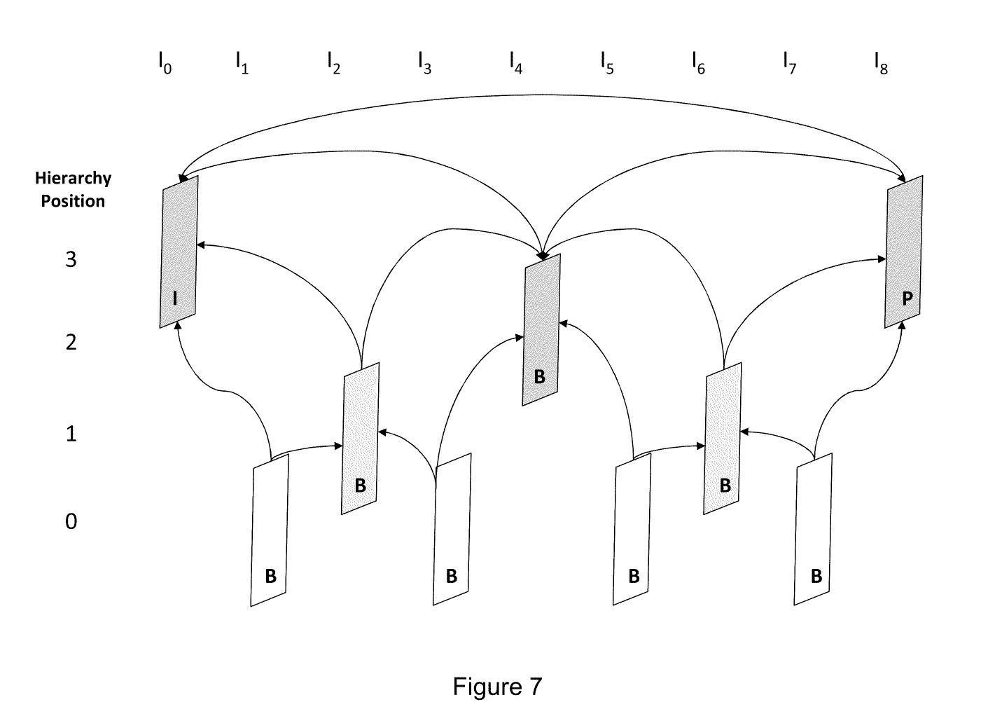

A group of pictures (GOP) composed of 9 images in sequence from I₀ to I₈ is represented in FIG. 7. These images are encoded according to a hierarchical organization in terms of order of temporal predictions: image I₀ is Intra encoded, image I₈ is a predicted image, and the other images I₁ to I₇ are encoded as B-images (with bi-directional temporal prediction). This structure is called a hierarchical B-frame structure. The arrows represented in FIG. 7 point from the B encoded image to the reference images used for the encoding. For example B encoded image I₇ has the hierarchy index 0 and is encoded from reference images I₆ (B-frame) and I₈ (P-frame) which are its immediate neighbors in terms of temporal distance. It can be noted that the higher the hierarchical position, the higher the temporal distance between the image and its reference images used for the temporal prediction. The hierarchical position is one of the encoding parameters of a given image or of a given slice.

The decision module 506 also takes into account the frame type (B-frame or P-frame) and the hierarchical position in the hierarchical organization of the temporal prediction to determine whether to apply the first or the second encoding mode to the motion vector predictors. Typically, for an image that is not used as a reference for temporal prediction for another image in the sequence, the motion vector predictors can be encoded using the first encoding mode, since no error propagation can occur due to parsing error in such an image.

The first encoding mode can be systematically applied for B-frames which are predicted from distant reference images (for example, B-frames of hierarchy position 2 in the example of FIG. 7).

Further, if the first encoding mode is applied for a B-frame of low hierarchy position (hierarchy level equal to 0), then all B-frames with higher hierarchy level should also use the first encoding mode for the encoding of the motion vector predictors in order to increase the coding efficiency for these frames. Indeed, if a slice of low hierarchy level is lost, all the slices of higher hierarchy level that are predicted from that low hierarchy level slice are likely to suffer parsing errors.

Another criterion that can be used by module 506 is the distance to the following re-synchronization image (or IDR frame). Indeed, if the following re-synchronization image is temporally close, the visual impact of a freeze at the decoder is limited.

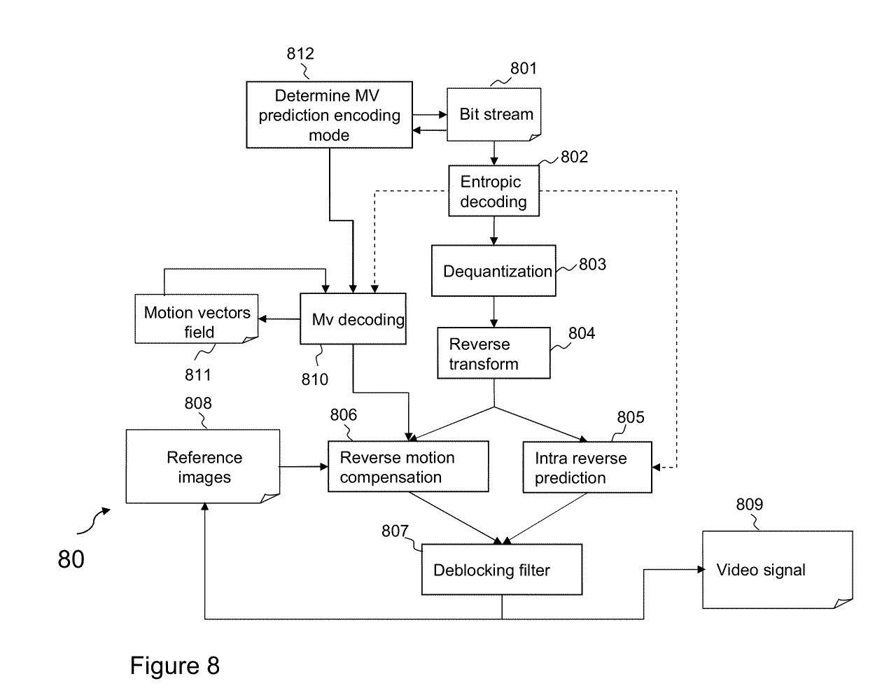

FIG. 8 illustrates a block diagram of a decoder according to an embodiment of the invention. The decoder is represented by connected modules, each module being adapted to implement, for example in the form of programming instructions to be executed by the CPU 1111 of device 1000, a corresponding step of a method implementing an embodiment of the invention.

The decoder 80 receives a bitstream 801 comprising encoding units, each one being composed of a header containing information on encoding parameters and a body containing the encoded video data. As explained with respect to FIG. 3, the encoded video data is entropy encoded, whereas the motion vector predictors indices may or may not be entropy encoded, according to the embodiment. The received encoded video data should be entropy decoded (802), dequantized (803) and then a reverse transform (804) has to be applied.

In particular, when the received encoded video data corresponds to a residual block of a current block to decode, the decoder also decodes motion prediction information from the bitstream, so as to find the reference area used by the encoder.

The bitstream also comprises, for example in each slice header in this embodiment, an item of information representative of the encoding mode applied for the motion vector predictors.

In a first embodiment, the encoding mode selected for the motion vectors predictors is either a first encoding mode applying a reduction process to obtain a reduced set of motion vector predictors followed by an entropy encoding of the index of the motion vector predictors selected, or a second encoding mode which does not apply the reduction process to obtain a reduced set of motion vector predictors.

The module 812 obtains an item of information, such as a binary flag, from the slice header of a current slice or more generally from the bitstream, to determine which encoding mode has been applied for the motion vector predictors at the encoder. This is either the first encoding mode which does not guarantee correct parsing in case of losses or the second encoding mode which guarantees correct parsing in case of losses.

In the first embodiment mentioned with respect to FIG. 3, the first encoding mode applies a reduction process whereas the second encoding mode does not apply a reduction process.

The module 812 monitors the module 810 which applies the motion vector decoding, switching between a first decoding mode corresponding to the first encoding mode and a second decoding mode corresponding to the second encoding mode.

For each block of the current image to decode, module 810 applies the motion vector predictor decoding to determine the index of the motion vector predictor used for the current block. The motion vector predictor is obtained from a set of motion vectors which are extracted from the motion vectors field 811. The index of the selected motion vector predictor within the set of motion vector predictors for the current block is obtained by entropy decoding 802.

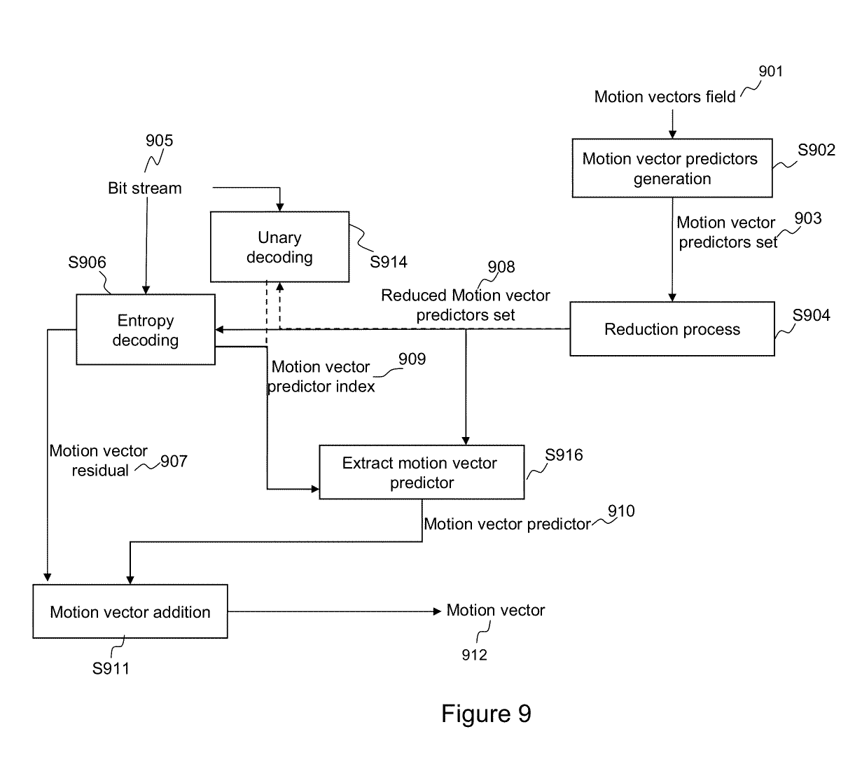

FIG. 9 described hereafter details the motion vector predictor decoding when using the reduction process. In this case, the number of motion vectors in the reduced set of motion vector predictors depends on the actual values taken by the motion vector predictors extracted from the motion vectors field 811.

If the reduction process is not applied, the number of motion vector predictors in the set is predetermined and does not vary according to the content values. In this case, the encoded data from the bistream can be correctly parsed, even in case of packet losses during transmission.

Once the index of the motion vector predictor for the current block has been obtained, the actual value of the motion vector associated with the current block can be decoded and used to apply reverse motion compensation (806). The reference area indicated by the decoded motion vector is extracted from a reference image (808) to finally apply the reverse motion compensation 806.

In case an Intra prediction has been applied, an inverse Intra prediction is applied by module 805.

Finally, a decoded block is obtained. A deblocking filter 807 is applied, similarly to the deblocking filter 315 applied at the encoder. A decoded video signal 809 is finally provided by the decoder 80.

In case of transmission errors and packet losses, typically some parts of the bitstream cannot be decoded and the resulting video signal 809 will contain errors such as frozen parts. When the second encoding mode for the motion vector predictors is applied, at least the corresponding bitstream can be parsed. For example, for a given slice for which the co-located reference slice has been lost, at least the Intra-coded blocks can be correctly decoded (when the Intra prediction doesn't take into account the neighboring pixel from Inter block), and consequently improving the visual quality of the resulting video signal.

In a second alternative embodiment, corresponding to the second embodiment of the encoder described with respect to FIG. 3, the reduction process is applied systematically. The encoding mode flag then indicates whether or not a prefix-type code, such as a unary code, has been used for encoding the index of the motion vector predictors. If the first encoding mode is indicated by module 812, then an entropy encoding has been applied to the index of the motion vector predictor. If the second encoding mode is indicated by module 812, then a unary encoding has been applied to the index of the motion vector predictor, so a unary decoding is applied to retrieve the index of the motion vector predictor for each block.

FIG. 9 details the embodiment of the motion vector decoding (module 810 of FIG. 8) when the process of reduction of the set of motion vector predictors is applied. All the steps of the algorithm represented in FIG. 9 can be implemented in software and executed by the central processing unit 1111 of the device 1000.

The motion vector decoding module 810 receives as an input a motion vector field 901, comprising the motion vectors computed for the blocks of the digital images previously decoded. The vectors of the motion vector field 901 are used as reference.

In step S902, a set of motion vector predictors 903 is generated. This step is similar to step S403 of FIGS. 4A and 4B. For example, the motion vector predictors of the predetermined blocks in the neighbourhood of the current block being processed are selected, as well as the motion vector of the co-located block in a reference image.

The reduction process is applied in step S904 to the motion vector predictors set 903 to obtain a reduced motion vector predictors set 908. Step S904 is similar to step S405 applied at the encoder. The reduction is based on the values actually taken by the motion vectors of the motion vector predictors set 903.

In the first embodiment the number of motion vectors of the reduced motion vector predictors set 908 is used as a parameter to retrieve, via entropy decoding applied in step S906, the index of the motion vector predictor 909 for the current block.

The decoded index 909 is used in step S916 to extract the motion vector 910 from the reduced motion vector predictors set 908. Motion vector 910 is the motion vector predictor for the current block. The motion vector residual 907 is also obtained by entropy decoding in step S906 and is added to the motion vector predictor 910 in a motion vector addition step S911 to obtain the actual motion vector 912 associated with the current block to decode.

If the reduction process is not applied, when the module 812 indicates the second decoding mode, then the motion vector predictors set 903 is directly used to obtain the motion vector predictor 910. The entropy decoding is applied to obtain the motion vector predictor index 909, however the number of motion vectors in the motion vector predictors set 903 is known in advance, so that the entropy decoding can be applied systematically, without being dependent on the current block. Step 911 remains unchanged.

In the second embodiment, if the second encoding mode is indicated by module 812, the index of the motion vector predictor is obtained by unary decoding in S914, independently of the number of motion vectors of the reduced motion vector predictors set 908. The motion vector predictor index 909 obtained is then similarly used to extract the motion vector predictor in step S916.

In an advanced embodiment, in the case where an image is divided into several slices, the spatial neighbourhood of the slices is taken further into account. Taking the example of FIG. 6, consider that slice 601 is encoded using the second encoding mode, i.e. so that the bitstream can be parsed even in case of losses or errors and slice 602 is encoded using the first encoding mode based on the determination criterion (for example, slice 602 corresponds to a static area). Using the second encoding mode, slice 601 can be parsed in any case. However, if a previous co-located slice is lost, then the actual values of the motion vectors cannot be precisely obtained. For example, the values of motion vectors V₁ and V₂ represented on FIG. 6 are not available. However, this has an effect on the following slice 602, since for example for the block B_{curr}, some motion vectors of the set of motion vector predictors are from blocks belonging to the previous slice 601. Consequently, the decoder would not be able to parse slice 602 because some its motion vector predictors are taken from a corrupted slice 601. Therefore, it would be necessary to prevent the use of spatial predictors coming from another spatial slice, in particular from a slice previously encoded/decoded, even when the reduction process can be used.

It is possible to constrain the encoder and decoder to the use only of motion vector predictors in a given slice. In order to apply such a restriction only when appropriate, it is possible to signal the use of such a constraint in the bitstream, by introducing a supplementary flag, for example in the slice header, indicating whether or not spatial motion vector predictors from another spatial slice are allowed or forbidden.

Other alternative embodiments may be envisaged, such as for example combining the unary encoding and the entropy encoding without reduction process in order to achieve an encoding which can be parsed at a decoder without error in case of losses in the bitstream.

More generally, any modification or improvement of the above-described embodiments, that a person skilled in the art may easily conceive should be considered as falling within the scope of the invention.

1. Method of encoding a sequence of digital images into a plurality of encoding units forming a bitstream to be provided to a decoder, at least one portion of an image being encoded by motion compensation with respect to a reference image portion indicated by an item of motion information, comprising determining a motion information predictor among a set of motion information predictors and encoding said item of motion information with respect to said motion information predictor,
wherein, for at least one said encoding unit, the method further comprises:
determining an encoding mode for the motion information predictors of said encoding unit between a first encoding mode and a second encoding mode, said second encoding mode providing encoded data that can be systematically parsed by said decoder, even in case of losses in the bitstream, and
signaling in the bitstream said determined encoding mode for the motion information predictors in association with said encoding unit.

2. A method according to claim 1, wherein the signaling comprises inserting in the bitstream an item of information representative of the determined encoding mode for the motion information predictors.

3. A method according to claim 1, wherein, for each portion of image of said encoding unit, said first encoding mode comprises:
applying a reduction of said set of motion information predictors to obtain a reduced set of motion information predictors, said reduction being based on the values taken by the set of motion information predictors for said portion of image, and
obtaining an item of information representative of a motion information predictor for said portion of image dependent upon the reduced set of motion information predictors,
and wherein said second encoding mode comprises obtaining an item of information representative of a motion information predictor for said portion of image dependent upon the set of motion information predictors.

4. A method according to claim 3, wherein the signaling comprises inserting in the bitstream an item of information indicating whether not the reduction of said set of motion information predictors has been applied.

5. A method according to claim 3, wherein said item of information indicating the reduction is a binary flag.

6. A method according to claim 1, wherein, for each portion of image of said encoding unit, said first encoding mode comprises obtaining an item of information representative of a motion information predictor for said portion of image by applying entropy encoding and wherein said second encoding mode comprises obtaining an item of information representative of a motion information predictor for said portion of image by applying a prefix-type encoding.

7. A method according to claim 6, wherein both said first and second encoding modes comprise applying a reduction of said set of motion information predictors to obtain a reduced set of motion information predictors, said reduction being based, for each portion of image, on the values taken by the set of motion information predictors for said portion of image to encode.

8. A method according to claim 1, wherein the determining of an encoding mode is based on a criterion taking into account the content of said sequence of digital images to encode and/or an encoding parameter of said encoding unit and/or an encoding parameter of said sequence of digital images to encode.

9. A method according to claim 8, wherein said content of said sequence of digital images to encode is a motion activity computed for said the encoding unit, and wherein:
in case of low motion activity, said first encoding mode of the motion information predictors is applied, and
in case of high motion activity, said second encoding mode of the motion information predictors is applied.

10. A method according to claim 9, wherein said encoding unit is an image slice, and wherein said motion activity is computed by:
computing an average value of the items of motion information of the portions of image belonging to a plurality of slices located in the same spatial position as the image slice to encode, and
comparing said average value to a predetermined threshold.

11. A method according to claim 8, comprising a hierarchical organization of reference images and wherein said encoding parameter of the encoding unit is an index representative of the hierarchical level associated with said unit to encode.

12. A method according to claim 1, wherein said bitstream is intended to be transmitted to a said decoder via a communication network, the determining of an encoding mode being based on a criterion taking into account a characteristic of said communication network.

13. A method according to claim 1, wherein a said-digital image to encode is divided into a plurality of slices, the method further comprising inserting in an encoding unit corresponding to a given slice an item of information adapted to indicate the use or not of any motion information predictor from any other slice different from said given slice.

14. Method of decoding a bitstream comprising an encoded sequence of digital images, the bitstream comprising a plurality of encoding units, at least one portion of an image being encoded by motion compensation with respect to a reference image portion indicated by an item of motion information, said item of motion information being encoded with respect to a motion information predictor selected among a set of motion information predictors,
wherein, for at least one said encoding unit, the method comprises:
obtaining from the bitstream an item of information indicating whether an encoding mode for the motion information predictors is a first encoding mode or a second encoding mode, said second encoding mode providing encoded data that can be systematically parsed, even in case of losses in the bitstream, and
applying, according to the obtained item of information, one of first and second decoding modes, corresponding to said first and second encoding modes, to decode the motion information predictor of said encoding unit.

15. A method according to claim 14, wherein, for each portion of image of said encoding unit, said first decoding mode comprises:
applying a reduction of said set of motion information predictors to obtain a reduced set of motion information predictors, said reduction being based on the values taken by the set of motion information predictors of said portion of image, and
obtaining an item of information representative of a motion information predictor for said portion of image dependent upon the reduced set of motion information predictors,
and wherein said second decoding mode comprises obtaining an item of information representative of a motion information predictor for said portion of image dependent upon the set of motion information predictors.

16. A method according to claim 14, wherein, for each portion of image of said encoding unit, said first decoding mode comprises obtaining an item of information representative of a motion information predictor for said portion of image by applying entropy decoding and wherein said second decoding mode comprises obtaining an item of information representative of a motion information predictor for said portion of image by applying a prefix-type decoding.

17. Device for encoding a sequence of digital images into a plurality of encoding units forming a bitstream to be provided to a decoder, at least one portion of an image being encoded by motion compensation with respect to a reference image portion indicated by an item of motion information, the device comprising
a motion-information-predictor determining unit which determines for at least one encoding unit a motion information predictor among a set of motion information predictors,
a motion-information-item encoder which encodes said item of motion information with respect to said motion information predictor,
a mode determining unit which determines whether to encode the motion information predictors of said encoding unit using a first encoding mode or a second encoding mode, said second encoding mode providing encoded data that can be systematically parsed by said decoder, even in case of losses in the bitstream, and
a signaling unit which signals in the bitstream said determined encoding mode for the motion information predictors in association with said encoding unit.

18. Device for decoding a bitstream comprising an encoded sequence of digital images, the bitstream comprising a plurality of encoding units, at least one portion of an image being encoded by motion compensation with respect to a reference image portion indicated by an item of motion information, said item of motion information being encoded with respect to a motion information predictor selected among a set of motion information predictors,
wherein, the device comprises:
an obtaining unit which, for at least one said encoding unit, obtains from the bitstream an item of information indicating whether an encoding mode for the motion information predictors is a first encoding mode or a second encoding mode, said second encoding mode providing encoded data that can be systematically parsed by said decoder even in case of losses in the bitstream, and
a decoding mode applying unit which applies, according to the obtained item of information, one of first and second decoding modes, corresponding respectively to said first and second encoding modes, to decode the motion information predictor of said encoding unit.

19. A non-transitory computer-readable carrier medium carrying a bitstream comprising an encoded sequence of digital images, the bitstream comprising a plurality of encoding units, at least one portion of an image being encoded by motion compensation with respect to a reference image portion indicated by an item of motion information, said item of motion information being encoded with respect to a motion information predictor selected among a set of motion information predictors, said bitstream comprising, for at least one said encoding unit, an item of information indicating whether an encoding mode for the motion information predictors of said encoding unit is a first encoding mode or a second encoding mode, said second encoding mode providing encoded data that can be systematically parsed by a decoder even in case of losses in the bitstream.

20. A non-transitory carrier medium carrying a computer program which, when run on a computer, causes the computer to carry out a method for encoding a digital video signal in which at least one portion of an image is encoded by motion compensation with respect to a reference image portion indicated by an item of motion information, the program comprising:
a code portion which determines a motion information predictor among a set of motion information predictors
a code portion which encodes said item of motion information with respect to said motion information predictor,
a code portion which, for at least one encoding unit, determines an encoding mode for the motion information predictors of said encoding unit between a first encoding mode and a second encoding mode, said second encoding mode providing encoded data that can be systematically parsed by said decoder, even in case of losses in the bitstream, and
a code portion which signals in the bitstream said determined encoding mode for the motion information predictors in association with said encoding unit.

21. (canceled)

22. A non-transitory carrier medium carrying a computer program which, when run on a computer, causes the computer to carry out a method of decoding a bitstream comprising an encoded sequence of digital images, the bitstream comprising a plurality of encoding units, at least one portion of an image being encoded by motion compensation with respect to a reference image portion indicated by an item of motion information, said item of motion information being encoded with respect to a motion information predictor selected among a set of motion information predictors,
the program comprising:
a code portion which, for at least one encoding unit, obtains from the bitstream an item of information indicating whether an encoding mode for the motion information predictors is a first encoding mode or a second encoding mode, said second encoding mode providing encoded data that can be systematically parsed, even in case of losses in the bitstream, and
a code portion which applies, according to the obtained item of information, one of first and second decoding modes, corresponding to said first and second encoding modes, to decode the motion information predictor of said encoding unit.
